(19) United States
(12) Patent Application Publication
(10) Pub. No.: US 2006/0099321 A1
(43) Pub. Date: May 11, 2006

(54) Cereal based food product comprising dha and/or epa

(75) Inventor: Birgit Sievert, Epalinges (CH)

Correspondence Address: BELL, BOYD & LLOYD LLC, P. O. BOX 1135, CHICAGO, IL, 60690-1135, US

(73) Assignee: Nestec S.A., Vevey (CH)

(21) Appl. No.: 10/523,765

(22) PCT Filed: Jul. 29, 2003
(86) PCT No.: PCT/EP03/08356

§ 371 Date: Sep. 1, 2005

(30) Foreign Application Priority Data
Aug. 7, 2002 (EP) 02017803.4

(51) Int. Cl. A23L 1/18

(52) U.S. Cl. 426/618

(57) ABSTRACT

The invention relates to a calcium absorption enhancer comprising as an active ingredient calcium and at least one of the components selected from the group of egg white, egg white proteins and isoflavones, as well as to an orally ingestible composition comprising it, and its use for different purposes, such as attenuating obesity, or increasing mobility.

### FIELD OF THE INVENTION

The present invention relates to cereal based food products comprising DHA (decosahexanoic acid) and/or EPA (eicosapentaenoic acid), without fish off-tastes and odours, and to a process for their preparation and/or manufacture.

### BACKGROUND OF THE INVENTION

Docosahexaenoic acid (DHA), a long-chain omega-3 polyunsaturated fatty acid, is important throughout pregnancy and lactation for the health of both the mother and her fetus/infant. A recent National Institutes of Health workshop of fatty acid experts recognizing the importance of maternal DHA intake recommended 300 mg/day of DHA as adequate intake for pregnant and lactating women. Some of the research prompting this recommendation includes:

Maternal DHA levels decline significantly in the last trimester, the period during which much maternal DHA is transferred from mother to fetus,

In preterm infants, DHA levels in the umbilical artery wall, which reflect the long-term fetal DHA status, have been positively correlated to newborn head circumference, weight and length,

In a dietary study of 119 pregnant or lactating women in the United States, the average intake of DHA was 54 mg/day, only 18% of that recommended by experts. Less than 2% of these women met the recommended DHA average intake,

Increasing maternal DHA intake during pregnancy, through diet or supplements, increases maternal and newborn DHA levels,

DHA was cited as the likely component of breast milk affecting significant increases in cognitive outcomes of breast-fed infants through the first eighteen years of life,

Even up to two years of age, breast-fed infants have higher skeletal muscle DHA and lower blood glucose levels than formula-fed infants,

At 6 weeks postpartum, maternal DHA levels remain lower than levels of non-pregnant women,

Reported DHA levels in breast milk of American women 15-26 are lower than what is recommended for formula-fed infants by a joint expert committee of the World Health Organization and the Food and Agriculture Organization,

During lactation, increasing maternal intake of DHA with dietary supplements improves maternal, breast milk and infant DHA levels.

To answer this well know and health-concerning problem, some companies have launched products, such as cereal bars, containing DHA. For example, Arkopharma Laboratories have launched snack bars (Gouter Vitalite®) for pregnant women, enriched with vitamins, minerals, essential nutrients, calcium, zinc, iron, magnesium, phosphorous, 10 vitamins and folic acid. Each bar contains 65 calories and it is recommended that one to two should be eaten each day. The ingredients include, among others, rice flour, corn flour, vegetable fatty matter, calcium phosphate, saccharose, salt, magnesium oxide, flavouring, vitamin C, DHA, vitamin E, vitamin PP, antioxidant (palmitate ascorbate) and natural tocopherols.

WO 0072842 to KV Pharmaceutical Company discloses a composition comprising a first fatty acid such as linoleic or linolenic acid in a range of 10 to 1000 mg, a second fatty acid such as DHA in a range of 10 to 1000 mg, vitamin C or a derivative thereof (i.e. ascorbate) in a range of 25 to 500 mg, and further vitamins and minerals. The composition disclosed may be in the form of any acceptable dosage forms, such as health bars, and may be in the form of cereals.

However, DHA is well known to have a very strong odour and off-taste of fish oil, rejected by the consumer. Numerous attempts have been made to mask the off taste of fish oil or DHA. For example, EP 296117 to Warner-Lambert Co proposes to render unpleasant tasting edible oil palatable by adding a sensory masking agent. The sensory masking agent can be a taste-masking agent such as anethole, dihydroanethole, eugenol, vanillin, ethylvanillin, ethyl maltol. It can also be an artificial or natural odour masking agent, such as lime, lemon, orange, pineapple, grapefruit, cinnamon, clove, bay, allspice, anise, wintergreen, spearmint, benzaldehyde or cherry.

Furthermore, the use of ascorbic acid or its derivatives is a well-known method for preventing oxidation of fish oil or DHA. JP 07107938 to Saneigen FF1 KK discloses an emulsion composition for food, pharmaceuticals, cosmetics and pet food containing docosahexanoic acid and vitamin C, for long-term storage, avoiding odour change or rapid oil oxidation of e.g. purified palm oil.

EPA is an omega-3 LC-PUFA with 20 carbon atoms and 5 methylene-interrupted cis-double bonds. The presence of EPA in the diet seems to promote antithrombotic processes in the body. Studies among the people having a traditional marine diet, rich in EPA, show a low evidence of coronary heart diseases.

However, none of the prior experiences to mask or to remove the strong off-tastes and odours of DHA and EPA have been successful, and edible products containing DHA and/or EPA are still rejected by the consumer because of this long lasting, strong and very unpleasant fish off-taste.

### SUMMARY OF THE INVENTION

We have now surprisingly found that it is possible to obtain cereal based food products comprising DHA and/or EPA, even at high concentrations, without off-taste. The cereal based food product according to the invention has a water activity between 0.2 and 0.4 and comprises encapsulated DHA and/or EPA and citrus flavour.

Additional features and advantages of the present invention are described in, and will be apparent from, the following Detailed Description of the Invention.

### DETAILED DESCRIPTION OF THE INVENTION

We have found that by combining these characteristics, the off-tastes and odours of the DHA and/or EPA contained in the cereal based food product according to the invention completely disappear, and this applies for relatively small contents of DHA and/or EPA, such as 108 mg DHA and/or EPA per 100 grams of cereal based food product, for example, as well as for very high contents of DHA and/or EPA, such as 1304 mg and even up to 2174 mg of DHA and/or EPA per 100 grams of cereal based food product. This allows the intended consumer to eat strongly decrease the amount of cereal based food products containing DHA and/or EPA ingested per day and at the same time reach the recommended daily intake of about 600 mg. As the intended population for a cereal product comprising DHA consists mainly in pregnant women and lactating women who, in most cases, have to look closely after their daily intakes, and especially their daily calorie intake, eating a small number of cereal based food products and still ingesting a high amount of DHA is a good answer to their needs. The intended population for cereal bars comprising EPA is a population conscious of cardio-vascular diseases and who are trying to prevent having cardiovascular diseases such as coronary heart diseases, for example.

It has to be understood that cereal products according to the invention can comprise both DHA and EPA, or just one of them. In the context of the present specification, it has to be understood that the invention works both for DHA and for EPA. The detailed description focuses more on the DHA aspect, but EPA is as well covered by the present invention. In most cases, where “DHA” is written, it can de understood “DHA and/or EPA”.

According to the invention, the aforementioned conditions to remove the off-tastes and odours have to be present. Indeed, if one element is missing, the off-tastes remain or appear very soon after the production, and the bar meets the prior bars disadvantages.

The advantages achieved by the invention are still present even when high amounts of effective DHA and/or EPA are incorporated into the cereal based food product. Accordingly, the DHA content for 100 grams of cereal based product do not exceed 2174 mg. Preferably, the DHA for 100 grams of cereal based product do not exceed 1739 mg, and in the preferred embodiment is 1304 mg.

The cereal based food product according to the invention can have different shapes or appearance forms. For example, it can be shaped as a stick, a cake, a macaroon, or it can be muesli-like (free cereals), flakes, or a bar. It can be consumed alone or in association with dairy products such as milk, yoghurts, cottage cheeses, or the like. A preferred product appearance is a cereal bar of 23 grams.

One of the characteristics of the invention lies in the presence of flavours. Preferably, the flavours are extracted from the Rutaceae family (Sapindales order), and most preferably from the Citrus genus. This includes, according to the invention, flavours from species Citrus aurantifolia (Christm.) Swingle (lime), Citrus aurantium L. (sour orange), Citrus limetta Risso (bitter orange), Citrus lemon (L.) Burm. F. (lemon), Citrus limonia Obsbeck (pro sp.) (mandarin lime), Citrus maxima (Burm. F.) Merr (shaddock), Citrus medica L. (citron), Citrus paradisi Macfad. (pro sp.) (grapefruit), Citrus reticulata Blanco (tangerine), and Citrus sinensis (L.) Osbeck (sweet orange). This aspect of the invention can be understood as comprising flavours of one or more of the aforementioned species.

Examples of particularly suitable flavours are lemon tertrarome liquid 987317 (catalogue number) by Firmenich or orange tetrarome liquid 987431 (catalogue number) by Firmenich, among others.

The preferred flavours are orange, lemon, and/or grapefruit flavours.

The flavour content within one cereal based product can be comprised between 0.01 to 0.20 wt %, preferably 0.07 to 0.17, most preferably 0.10 to 0.15, and in a most preferred embodiment 0.13%. Accordingly, if the cereal based product weighs 23 grams, the flavour content of said food product can be comprised, in mg per product, between 2.3 and 46 mg, preferably 16.1 and 39.1 mg, most preferably 23 and 34.5 mg, and in a most preferred embodiment is 29.9 mg flavour/product.

It has to be understood that in addition to these flavours, other flavours can be added, such as, for example, honey, fruit, chocolate, caramel, nuts, almonds, yoghurt flavours or a combination thereof.

The flavours used are preferably added into the cereal based food product either in powdered form or associated with alcohol. They can also be added associated with water or water-containing liquids in the limit of the water activity value which, as stated above, must be kept between 0.2 and 0.4.

Water activity can be defined as the ratio of the water vapour pressure of a product to the vapour pressure of pure water at the same temperature. The cereals and especially the binder must meet target water activity. If the target water activity is exceeded, free water will migrate into the cereals. Moisture transfer may generate loss of the crispy texture, a matt appearance, the development of stale notes/off-tastes and may accelerate fat oxidation reactions and therefore, the bar will not be shelf stable. The low water activity of the finished bars and the packaging material guaranty that the critical product moisture is not reached. Accordingly, the water activity of the cereal based food product comprising DHA and/or EPA should be comprised between 0.2 and 0.4, preferably 0.25 to 0.38, most preferably 0.30 and 0.35, and in a most preferred embodiment can be 0.33.

DHA and/or EPA must be encapsulated in an ingestable component forming a closed barrier between DHA and/or EPA and the rest of the product or the atmosphere. Accordingly, encapsulating DHA and/or EPA in a matrix is not sufficient, for the purpose of the present invention. Examples of encapsulation fulfilling the requirements of the present invention are encapsulations in sugar, proteins, fats glycerol, or a mixture of monosaccharides and alcohol such as propanetriol, for example. According to the invention, the effective amount of DHA can vary up to 500 mg per 23 grams of cereal based food product, that is to say 2.174 grams of DHA for 100 grams of cereal based food product in the case of a 23 grams cereal bar. It has to be understood that the effective amount of DHA and/or EPA is calculated on a 100% basis and consequently does not refer to DHA plus encapsulating material.

It is also possible to add some other components to the cereal based food product according to the invention, such as glycerol, honey, prebiotics, probiotics, antioxidants and oxygen absorber, among others.

“Prebiotic” means a substance or compound which is fermented by the intestinal flora of a pet and/or a human and hence promotes the growth or development of bifido- and lactic-bacteria in the gastro-intestinal tract at the expense of pathogenic bacteria. Suitable prebiotics include oligosaccharides, such as inulin and its hydrolysis products commonly known as fructooligosaccharides, galacto-oligosaccarides, xylo-oligosaccharides or oligo derivatives of starch. The prebiotics may be provided in any suitable form. For example, the prebiotic may be provided in the form of plant material which contains the prebiotic. Suitable plant materials includes asparagus, artichokes, onions, wheat or chicory, or residues of these plant materials. Alternatively, the prebiotic may be provided as an inulin extract. Extracts from chicory are particularly suitable. Suitable inulin extracts are commercially available.

“Probiotic micro-organism” means a micro-organism which beneficially affects a host by improving its intestinal microbial balance (Fuller, R; 1989; J. Applied Bacteriology, 66: 365-378).

The probiotic micro-organism may be selected from one or more micro-organisms suitable for animal and/or human consumption and which is able to improve the microbial balance in the intestine. Examples of suitable probiotic micro-organisms include yeasts such as Saccharomyces, Debaromyces, Candida, Pichia and Torulopsis, moulds such as Aspergillus, Rhizopus, Mucor, and Penicillium and Torulopsis and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Saccharomyces cereviseae, Bacillus coagulans, Bacillus licheniformis, Bacillus subtilis, Bifidobacterium bifidum, Bifidobacterium infantis, Bifidobacterium longum, Enterococcus faecium, Enterococcus faecalis, Lactobacillus acidophilus, Lactobacillus alimentarius, Lactobacillus casei subsp. casei, Lactobacillus casei Shirota, Lactobacillus curvatus, Lactobacillus delbruckii subsp. lactis, Lactobacillus farciminus, Lactobacillus gasseri, Lactobacillus helveticus, Lactobacillus johnsonii, Lactobacillus reuteri, Lactobacillus rhamnosus (Lactobacillus GG), Lactobacillus sake, Lactococcus lactis, Micrococcus varians, Pediococcus acidilactici, Pediococcus pentosaceus, Pediococcus acidilactici, Pediococcus halophilus, Streptococcus faecalis, Streptococcus thermophilus, Staphylococcus carnosus, and Staphylococcus xylosus. The probiotic micro-organisms may be in powdered, dried form; especially in spore form for micro-organisms which form spores. Further, if desired, the probiotic micro-organism may be encapsulated to further increase the probability of survival; for example in a sugar matrix, fat matrix or polysaccharide matrix.

Antioxidants inhibit oxidation by molecular oxygen, and are commonly used to delay fat staling. Primary antioxidants act by blocking free radicals such as peroxide radicals, which are responsible for the first oxidation step of unsaturated fatty acids. Secondary antioxidants act either by chelating metallic ions, which are the oxidation catalysts, or by inhibiting lipoxygenases. Suitable antioxidants are, for example, L ascorbic acid, 1 sodium ascorbate, 1 calcium ascorbate, ascorbyle palmitate, alpha, delta or gamma tocopherols, BHA (butylhydroxyanisol), BHT (butylhydroxytoluene), lactic acid, sodium, potassium or calcium lactates, citric acid, and more generally anti-oxygens E 300 to E 309, E 311 and E 312, E 320 to E 322, E 220 to E 224, E 226, E 270, E 325 to E 327, E 330 to 341, and E 472c (European Economic Community numerotation)

Preferably, no minerals such as iron or copper are added, as they are catalysts for fat oxidation. If minerals are added encapsulated minerals are preferred. Oxygen absorbers, such as sodium ascorbate, can also be added to the cereal based food product comprising DHA and/or EPA.

If the cereal based food products according to the invention have to be stored before they are consumed, which is generally the case, they are preferably preserved in a package comprising a modified atmosphere or an oxygen absorber. The DHA and/or EPA containing cereal based food products can be packed under inert gas for example, with N₂. The inert gas can be any other gas known by the skilled person for its use in food-containing packaging, such as CO₂, for example. An important target is that the modified atmosphere has to contain less than 0.5% of oxygen. Accordingly, the longer the cereal based food products containing DHA and/or EPA are stored, the most important is the modified atmosphere inside the packaging or the presence of an oxygen absorber. Indeed, if said food product is stored less than one week before its consumption, a modified atmosphere or an oxygen absorber, although it is preferable, is not necessary.

According to another aspect of the invention, there is a process for making a cereal based food product comprising DHA and/or EPA with no off-taste and odour, even at high concentrations of DHA and/or EPA. Accordingly, DHA and/or EPA is encapsulated by any food grade encapsulation process known by the skilled person. The encapsulation must lead up to an embedded encapsulation wherein exchanges with the other components of the bar and the atmosphere are as reduced as possible. Then, DHA and/or EPA is mixed with cereals such as, for example, corn flakes, rice crisps, shredded wheat, oats, millet and the like, or a combination thereof. The cereals can be of any suitable form, such as flakes, crisps, and balls, among others. In the cereal mix are also added rutaceae flavours such as orange flavours, or lemon flavours, for example. Separately, a binder is prepared by mixing at least sugars with an oxygen absorber, such as sodium ascorbate, and rutaceae flavours.

The binder ingredients are pre-weighed and transferred into a cooker and mixer machine. The ingredients must be homogeneously mixed, i.e. lump-free and dissolved under stirring and target temperature. The aim is to obtain the target water activity and then to add the DHA, sodium ascorbate and flavours at a maximum temperature of 80° C. Preferably, the temperature in the process is comprised between 30 and 80° C., most preferably between 40 to 60° C., and in a most preferred embodiment is 50° C. This low temperature protects DHA and/or EPA, sodium ascorbate and flavours from oxidation and other chemical transformations.

This mix is transported to a mixer for cereal/binder blend. The binder and cereals are then homogeneously mixed and the blend is immediately used for bar forming to minimise fat oxidation, especially of DHA and EPA.

Flavours are preferably added both in the cereal mix ingredients and in the binder ingredients. However, they can be added only in the cereal ingredients or only in the binder ingredients.

### EXAMPLES

The following examples are illustrative of some of the products and methods of making the same falling within the scope of the present invention. They are not to be considered in any way limitative of the invention. Changes and modifications can be made with respect to the invention. That is, the skilled person will recognise many variations in these examples to cover a wide range of formulas, ingredients, processing, and mixtures to rationally adjust the naturally occurring levels of the compounds of the invention for a variety of applications.

### Example 1

### Ingredient Description of Cereal Bars Containing DHA

| | Functional properties |
|---|---|
| Cereals | |
| Rice crisps | Cereal texture, taste, colour |
| Corn flakes small | Cereal texture, taste, colour |
| Natural Lemon flavour powder | Flavour, fish off-taste/odour |
| | masking agent |
| Natural Orange flavour powder | Flavour, fish off-taste/odour |
| | masking agent |
| Binder ingredients | |
| Glucose syrup | Binding, anti-crystallisation |
| | agent, sweetness |
| Sucrose | Sweetness, filler |
| Fish oil concentrated powder rich in DHA | Encapsulated DHA |
| | (docosahexaenoic acid) source |
| Glycerol | Humectant, a_{w} decrease |
| Invert sugar syrup | Binding, anti-crystallisation |
| | agent, sweetness, a_{w} decrease |
| Vegetable oil fractionated, non- | Taste, texture-lubrication |
| hydrogenated, non-lauric | |
| Honey | Taste, texture |
| Salt | Taste, a_{w} decrease |
| Sodium Ascorbate | Oxygen absorber |
| Honey flavour natural identical | Flavour |
| Natural Lemon flavour liquid | Flavour, fish off-taste/odour |
| | masking agent |
| Natural Orange flavour liquid | Flavour fish off-taste/odour |
| | masking agent |

### Example 2

### Shelf Life Datas

Shelf life tests and headspace analysis (oxidation test) were carried out at 37° C. (accelerated conditions) and at 20° C./70% relative humidity (rh). The products were analysed for sensory, pentane and residual oxygen. 90 days at 37° C. correspond to a shelf life of 12 months under ambient non-tropical conditions (−20° C.). The bars were stored in closed tins to exclude the effect of the packaging material or in the case of the modified atmosphere packaging (MAP) in the original packs. A scale from 0-10 evaluates the taste and odour. A rating <6 indicates a non-acceptable product.

Cereal Bar DHA 300 mg/Bar Lemon Flavored

| Analysis 37° C. at days/months | Start | 30/1 | 60/2 | 90/3 |
|---|---|---|---|---|
| A_{w} | 0.37 | 0.36 | 0.37 | 0.37 |
| Taste | | 8 | 8 | 9 |
| Texture | | Ok | Ok | Ok |
| Colour | | Good | Good | Good |
| Odour | | Good | Good | Good |

| Analysis 20° C. at days/months | 90/3 |
|---|---|
| A_{w} | 0.37 |
| Taste | 9 |
| Texture | Ok |
| Colour | Good |
| Odour | Good |

Cereal Bar DHA 300 mg/Bar Orange Flavored

| Analysis 37° C. at days/months | Start | 30/1 | 60/2 | 90/3 |
|---|---|---|---|---|
| A_{w} | 0.36 | 0.36 | 0.37 | 0.36 |
| Taste | | 8 | 8 | 9 |
| Texture | | Ok | Ok | Ok |
| Colour | | Good | Good | Good |
| Odour | | Good | Good | Good |

| Analysis 20° C. at days/months | 90/3 |
|---|---|
| A_{w} | 0.36 |
| Taste | 9 |
| Texture | Ok |
| Colour | Good |
| Odour | Good |

### Example 3

### Shelf Life Datas of DHA Bars Without the Combination of Citrus Flavours and MAP

Series of cereal based food products with DHA 200, 300, 400 mg/bar were produced without citrus flavour and without MAP. All products showed already after 1 month shelf life at 37° C. a strong fish off-taste and odour, while the water activity, moisture, pentane and residual oxygen were comparable to the reference product.

A triangular test was carried out with a DHA bar 200 mg/bar (without citrus flavoured and without MAP) against a reference bar. The samples were fresh, i.e. only one week aged.

The triangular test was significant in the sense that 16 out of 21 found a difference (99% level). However, 10 out of the 16 found attributes like fruity, honey—positive attributes, and only 6 out of the 16 found a negative off-taste like metallic, rancid. Overall, only one person identified a fish off-taste in the fresh bars, i.e. only one week aged.

Cereal Bar 300 mg/Bar Lemon Flavoured Without MAP

| Analysis 37° C. at days/months | Start | 30/1 | 60/2 | 90/3 |
|---|---|---|---|---|
| A_{w} | | 0.28 | 0.28 | 0.28 |
| Moisture % | 5.15 | | | |
| Taste | | 7* | Out** | |
| Texture | | Good | | |
| Colour | | Good | | |
| Odour | | Good | Out** | |
| Pentane, ppm | | 0.04 | 0.07 | 0.45 |
| Residual oxygen, % | | 20.7 | 20.6 | 21 |

| Analysis 20° C. at days/months | 90/3 |
|---|---|
| A_{w} | 0.29 |
| Taste | 6* |
| Texture | Good |
| Colour | Good |
| Odour | Slight-off* |
| Pentane, ppm | 0.02 |
| Residual oxygen, % | 20.6 |

Cereal Bar DHA 200 mg/Bar Without Citrus Flavours but with MAP

| Analysis 37° C. at days/months | Start | 30/1 | 60/2 | 90/3 | 120/4 |
|---|---|---|---|---|---|
| A_{w} | | 0.26 | 0.27 | 0.27 | 0.28 |
| Moisture % | 5.09 | | | | |
| Taste | | 9 | 7* | 6* | Out* |
| Texture | | Good | Ok | Good | |
| Colour | | Good | Good | Good | |
| Odour | | Good | Good | Good | Out** |

| Analysis 20° C. at days/months | 90/3 |
|---|---|
| A_{w} | 0.26 |
| Taste | 6* |
| Texture | Good |
| Colour | Good |
| Odour | Good |

Cereal Bar DHA 400 mg/Bar Without Citrus Flavours but with MAP

| Analysis 37° C. at days/months | Start | 30/1 | 60/2 | 90/3 | 120/4 |
|---|---|---|---|---|---|
| A_{w} | | 0.28 | 0.30 | 0.28 | 0.29 |
| Moisture % | 5.19 | | | | |
| Taste | | 8* | | 6* | Out** |
| Texture | | Good | | Ok | Ok |
| Colour | | Good | | Good | Ok |
| Odour | | Good | | Good | Out** |

| Analysis 20° C. at days/months | 90/3 |
|---|---|
| A_{w} | 0.28 |
| Taste | 6* |
| Texture | Ok |
| Colour | Good |
| Odour | Good |

In the previous tables of this example, the sign * means slight fish-off taste and odour, and the sign ** means strong fish-off taste and odour.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. Cereal based food product having a water activity between 0.2 and 0.4 and comprising at least one encapsulated component chosen from the group consisting of DHA and EPA and citrus flavour.

2. Cereal based food product according to claim 1 comprising an amount of DHA that does not exceed 2174 mg per 100 g food product.

3. Cereal based food product according to claim 1 wherein the citrus flavour is present in an amount between 0.01 and 0.20 wt %.

4. Cereal based food product according to claim 1 wherein the citrus flavour is present in an amount between 0.10 and 0.15 wt %.

5. Cereal based food product according to claim 1 wherein the citrus flavour is present in an amount of 0.13 wt %.

6. Cereal based food product according to claim 1 wherein the citrus flavour is chosen from the group consisting of orange, lemon, grapefruit, and mixtures thereof.

7. Cereal based food product according to claim 1 having a water activity between 0.28 and 0.38.

8. Cereal based food product according to claim 1 further comprising at least one component selected from the group consisting of glycerol, honey, prebiotics, probiotics, antioxidants, and oxygen absorber.

9. Cereal based food product according to claim 1 wherein the food product is in a shape selected from the group consisting of a stick, a cake, a macaroon muesli-like, flakes, and a bar.

10. Packaged food product comprising a package including a cereal based food product having a water activity between 0.2 and 0.4 and comprising at least one encapsulated component chosen from the group consisting of DHA and EPA and citrus flavour under a modified atmosphere.

11. Packaged food according to claim 11 wherein the modified atmosphere contains less than 0.5% volume of molecular oxygen.

12. Process for making a cereal food product comprising the steps of
(1) preparing a cereal mix by mixing cereals, encapsulated DHA and/or EPA and a first portion of citrus flavours,
(2) preparing a binder including a second portion of citrus flavours,
(3) mixing the product obtained under (1) and the product obtained under (2) to obtain a cereal food product having a water activity of between 0.2 and 0.4,
maintaining the temperature throughout the process so that it does not exceed 80° C.

13. Process according to claim 13 wherein the temperature throughout the process does not exceed 50° C.

14. A method of providing nutrition to pregnant and/or lactating women comprising the step of administering a cereal based food product having a water activity between 0.2 and 0.4 and comprising at least one encapsulated component chosen from the group consisting of DHA and EPA and citrus flavour including DHA to the women.

15. A method of preventing cardio-vascular diseases comprising the step of administering to an individual at risk of cardio-vascular disease a cereal based food product having a water activity between 0.2 and 0.4 and comprising at least one encapsulated component chosen from the group consisting of DHA and EPA and citrus flavour including EPA.

16. Cereal based food product according to claim 1 wherein the amount of DHA does not exceed 1739 mg/100 g.

17. Cereal based product according to claim 1 wherein the DHA does not exceed 1304 mg DHA/100 g food product.

18. Cereal based food product according to claim 1 having a water activity of 0.33.

19. Method according to claim 14 comprising an amount of DHA that does not exceed 2174 mg per 100 g product.

20. Method according to claim 15 comprising an amount of DHA that does not exceed 2174 mg per 100 g product.

21. Method according to claim 14 wherein the citrus flavour is present in an amount between 0.01 and 0.20 wt %.

22. Method according to claim 15 wherein the citrus flavour is present in an amount between 0.01 and 0.29 wt %.

23. Method according to claim 14 wherein the citrus flavour is present in an amount between 0.10 and 0.15 wt %.

24. Method according to claim 15 wherein the citrus flavour is present in an amount between 0.10 and 0.15 wt %.
